(19) United States
(12) Patent Application Publication
(10) Pub. No.: US 2002/0107804 A1
(43) Pub. Date: Aug. 8, 2002

(54) System and method for managing trust between clients and servers

(76) Inventor: David William Kravitz, Fairfax, VA (US)

Correspondence Address: BAKER & BOTTS, 30 ROCKEFELLER PLAZA, NEW YORK, NY, 10112

(21) Appl. No.: 10/015,201

(22) Filed: Oct. 19, 2001

Related U.S. Application Data
(60) Provisional application No. 60/242,083, filed on Oct. 20, 2000.
(60) Provisional application No. 60/246,843, filed on Nov. 8, 2000.

(51) Int. Cl. G06F 17/60

(52) U.S. Cl. 705/51

(57) ABSTRACT

A method and architecture that enables consumers to computer data from multiple providers without jeopardizing consumer privacy interests or intellectual property rights of providers is disclosed. The architecture includes a trust server that mediates the conferral and revocation of trust relationships between the two parties. The method also employs programmable security coprocessors at vulnerable sites requiring protection, namely at the trust server and at each consumer. The architecture further reflects the specific requirements of coprocessors within consumer-side installations and their server-side counterparts. A single coprocessor within a client platform serves multiple providers by allocating to each of them a virtualized trusted computing environment for software execution and data manipulation. Since the tamper-resistance offered by client-side coprocessors is subject to more stringent economic pressures than that offered by server-side hardware security modules (HSMs), the architecture includes containment capabilities that prevent compromised coprocessors from causing damage disproportionate to their numbers.

### SPECIFICATION

This application is based upon and claims priority from Provisional Patent Application Ser. No. 60/242,083, filed Oct. 20, 2000 and from Provisional Patent Application Ser. No. 60/246,843, filed Nov. 8, 2000, the entire specifications of which are incorporated by reference herein. This application also incorporates by reference the entire specification of Applicant's concurrently-submitted application Ser. No. ______, entitled “Cryptographic Data Security System And Method,” attorney docket no. A33940-067668.0136.

### BACKGROUND OF THE INVENTION

In recent years it has been recognized that protection of digital content, including content valuable because it comprises intellectual property, or because it comprises or includes sensitive personal or financial information, must involve the use of consumer-situated hardware. It has also been recognized that such hardware may play an important role in protecting the end-user, where such hardware is being deployed in the form of smart cards and other personal tokens to achieve safer access authentication. With respect to providers, dongles may be pointed to as examples of simple consumer-situated hardware that has achieved some success within its circumscribed objective of software copy protection.

The consumer-situated hardware, however, has almost no impact whatsoever on the Internet economy, where the lack is especially acute in the area of networked digital media. Some have recognized the opportunity in harnessing the Internet as a ground-breaking distribution channel. However, the challenges have been the cost of design, manufacture and mass market of such a special-purpose device, and its appeal to consumers and various industries such as consumer-electronics, content-distribution, and banking and Internet services.

Previously, it has been disclosed that one possibility of reducing the cost and increasing the appeal of such a consumer-situated security device may be by opening up access to more than one provider. In fact, if such hardware rather than serving multiple providers in a preprogrammed and narrowly defined manner instead does so flexibly by incorporating open programmability at its core, barriers preventing widespread consumer deployment may be substantially reduced. Open hardware may loosen the difficult close-coupling among disparate business entities otherwise necessary in order to actualize a fixed-purpose product. Successful accommodation of rival economic interests motivates the desirability of provider-independent manufacturers specializing in the comprehensive facilitation of security devices.

However, most or all prior art multi-use, provider-independent security hardware is believed to suffer from a common drawback in that it introduces other system design challenges, especially with respect to consumer privacy and coprocessor resiliency. The aforementioned security hardware's anonymous service utilizes access tokening systems, but anonymity on a multi-application trusted execution environment remains very much an open research topic. An important concern that has not been addressed is the fact that a particular system's infrastructural information may be shared among providers to form comprehensive profiles of each consumer. The certified public key of a consumer's security module is distributed to all providers with whom the consumer wishes to transact. The certified public key may then be shared among an unscrupulous subset of providers to create a revealing profile of the consumer's purchasing habits. Note that privacy-protecting features of the system design, while necessary, cannot be sufficient to meet a stringent privacy requirement if the underlying communication transport does not support anonymity features.

Another issue that deserves greater attention is the fact that an end-user coprocessor may be compromised by an adversary with sufficient resources. The trust infrastructure supporting all the goals of the above should feature resilience in such a scenario. A simple example is the prevention of an arbitrary number of clones of a compromised coprocessor from infiltrating the system. However, the context of a shared-usage, high-privacy system as described above makes the problem of architecting containment and damage limitation capabilities much harder.

Accordingly, there remains a need for a multi-use, provider-independent security hardware that provides increased privacy protection and coprocessor resiliency. The prior art is not believed to meet these needs.

### SUMMARY OF THE INVENTION

It is an object of the present invention to increase trust for secure relationship-based transactions between a client and at least one remote server.

It is another object of the present invention to provide control of computer object data used by a plurality of clients.

It is yet another object of the present invention to increase coprocessor resiliency.

In order to meet these and other objects that will become apparent with reference to further disclosure set forth below, the present invention provides methods for enhancing trust for transactions between a client using a client computer microprocessor platform and a remote server, and methods for providing control of computer object data deriving from source data associated with a remote server, where the object data is usable by a plurality of clients using client computer microprocessor platforms.

The present invention provides increased trust for transactions between a client using a client computer microprocessor platform and at least one remote server by employing a trusted server configured to accept at least one public key datum, where each public key datum is specifically associated with a client platform as part of a public/private key pair for the platform. The public/private key pair may be generated using at least one of the client platform and the trusted server.

Additional approval data is also associated with the public key datum to identify the public key datum as having been approved by the trusted server which accepts it. The public key datum and the associated additional approved data are then made available to the remote server, where the remote server is configured to recognize trustworthy additional approval data. Remote server-specific data is also associated with the approved public key datum, and the associated remote server-specific data is used in conjunction with the client platform private key associated with the public key datum. Through client platform communication with the trusted server, the trusted server is made aware of at least one utilization of the client platform private key with server-specific data from the remote server, giving the trusted server opportunity to accept or reject association of the public key datum with the remote server, and to provide or deny an assurance.

The present invention enhances trust for transactions between a client using a client computer microprocessor platform and a remote server by employing at least one trusted server and transferring data from the remote server to the trusted server. The transferred data includes at least one secret datum. The transfer is effected in conjunction with data transfer security provisions. A function of a portion of the transferred data is provided from the trusted server to the client platform, where the portion includes at least a part of the secret datum. The trusted server provides a value of the function to the client platform encrypted by at least one key recognizable by the trusted server as associated with a client platform deemed trustworthy. The client platform is operational to decrypt the encrypted function value, so that the function value may be securely shared between the remote server and the client platform.

The present invention also allows for trusted delivery of computer object data to a client computer microprocessor platform, where a remote server supplies source data of which the delivered object data is a function (e.g., a mathematical function (such as an algebraic function), a hash, a transform, the identical function, or another function having the object data as its argument). The delivery is accomplished by identifying a secret datum that is known to the remote server. The secret datum is made available to a trusted server and identified with a unique tag. The computer object data is derived from the submitted source data, where the object data is associated with a signature computed by the trusted server and where the signature is a function of the object data. The computer object data is then provided for use at a client platform.

The present invention provides control of computer object data deriving from source data associated with a remote server, where the object data is usable by a plurality of clients using client computer microprocessor platforms, by identifying a first datum associated with a unique tag. Both the first datum and the associated tag are known to the remote server. A second datum is then associated with the first datum and tag, where the second datum is provided by a trusted server which is configured to store information reflecting the first datum and tag and second datum. Computer object data is then bound to a value computed as a function of a derived datum, wherein the derived datum comprises at least one of data indicative of the first datum and data indicative of the second datum. The binding is performed by the trusted server. An additional data bundle is also formed by associating for the remote server additional data of the remote server with: i) at least one of data indicative of the first datum and data indicative of the second datum and; ii) the associated tag. The additional data bundle is submitted to a trusted server for verification. If the bundle is verified as consistent with the stored information regarding the first datum and tag and the second datum as stored by the trusted server, then the derived datum is associated with functions of the data bundle for delivery to a client platform.

In one embodiment of the invention, the first datum can include or is a secret datum. Additionally, the derived datum may include or be an encryption key.

### BRIEF DESCRIPTION OF THE DRAWINGS

The accompanying drawings, which are incorporated into and constitute part of this disclosure, illustrate preferred embodiments of the invention and serve to explain the principles of the invention.

FIG. 1 is an illustrative diagram presenting an overview of the invention and its trust framework.

FIG. 2 is a block diagram presenting the encryption process of a Secure Application Component (SAC) by the Application Server (AS).

FIG. 3 is a block diagram illustrating coupon-collection and coupon-redemption of the SAC individualization process by a coprocessor (Cp) on a client platform.

FIG. 4 is a block diagram presenting SAC-series initialization in a SAC individualization process by Application Server and Trust Server (TS).

FIG. 5 is a block diagram presenting the SAC publishing process in the SAC individualization process by Application Server and Trust Server.

FIG. 6 is a block diagram presenting a SAC-series bulk individualization by Application Server and Trust Server.

FIG. 7 is a block diagram illustrating SAC permissioning into a coprocessor.

### DETAILED DESCRIPTION OF THE PREFERRED EMBODIMENTS

Computers in common use, such as client-side computers (e.g., personal computers of a business or individual user having access to a distributed data network such as the Internet, by which they can be linked to various servers) generally contain coprocessors. The use of the term coprocessor is restricted herein to refer to coprocessors used at the level of consumers/clients. Its server-class counterpart is denoted by the term Hardware Security Module (HSM). Secure coprocessors may be categorized into several types as disclosed in S. W. Smith, E. R. Palmer, and S. H. Weingart, “Using a High-Performance, Programmable Secure Coprocessor”, Proceedings, Second International Conference on Financial Cryptography, Springer-Verlag LNCS, 1998. The coprocessor envisioned to support the secure open system overlaps several of these categories. An open programming environment is clearly preferred, which appears to place such a coprocessor in the same realm as that of an HSM, namely, high-end secure coprocessors. On the other hand, the coprocessor may well have to serve within resource-constrained consumer appliances. A coprocessor with such an embedded footprint appears to fit better within the category of cryptographic accelerators.

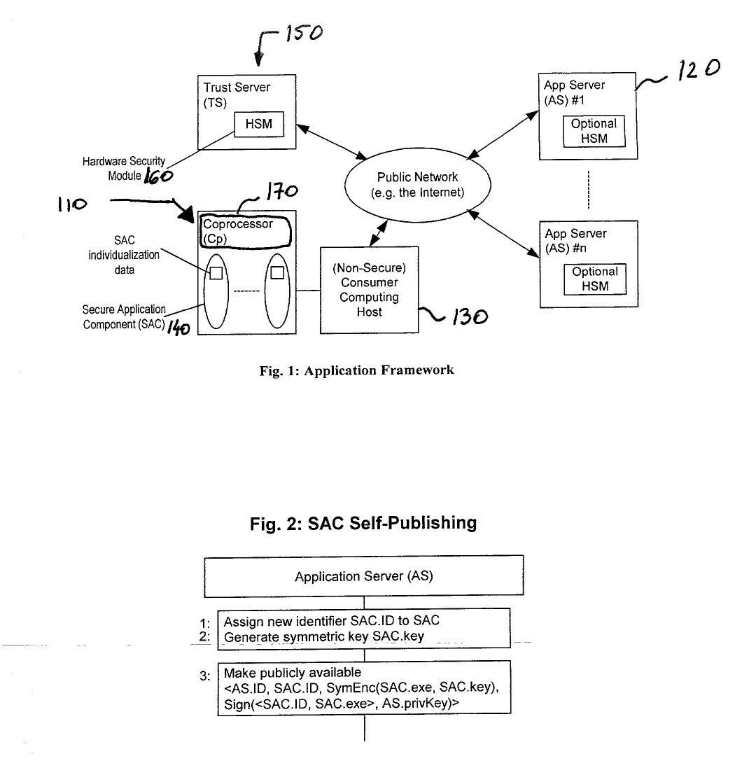

With respect to FIG. 1, an exemplary application and Trust Framework of the present invention will now be described.

A typical service or application delivered by a provider in this model involves three entities: an application server (AS) 120 also denoted as a remote server, the conventional, non-secured consumer-situated host device 130, and a coprocessor's trusted execution environment 110. The software application component running within this client-side trusted execution environment is called a Secure Application Component (SAC) 140. The totality of the client-side computing installation is denoted as a client computer microprocessor platform or client platform. Computer object data may comprise the SAC executable, and source data may comprise the source (code) of a SAC or the SAC executable.

The trust server component 150, also designated as a trusted server, is motivated by studying the two degenerate cases corresponding to the relaxation of one of the privacy or of the containment objective.

Where containment is not necessary, ensuring that coprocessors are formally indistinguishable coprocessors coupled with any of a number of anonymous access schemes is sufficient to ensure privacy. Note that this result is independent of the feature set of the trusted execution environment; code can be transported confidentially and with both origin authentication and integrity checks to any particular coprocessor. The requirement is only that coprocessors, if indeed cryptographic key material has to be preloaded into them, all obtain the same data.

Conversely, if only containment is desired, then unique certified public keys for each coprocessor may be used to allow the provider to track billing and revoke trust in detectably compromised hardware.

When both containment and privacy are required, a trusted intermediary is necessary to broker the conferral and revocation of trust relationships between consumers and providers. Hence, a Trust Server 150 is used as such an intermediary. Knowledge of the association between a coprocessor 170 and an instance of a SAC 140 must be confined to the Trust Server 150 in order to maximally protect the privacy of the consumer or client using the coprocessor 170.

The necessity of coprocessor individualization is obvious from the preceding discussion. The requirement for individualization of an SAC 140 follows from the necessity of a provider to keep track of its separate instances across coprocessors 170. Two methods for individualizing a SAC 140 may be used: SAC individualization by a provider's Application Server 120, and SAC individualization by the Trust Server 150.

There is a question whether a SAC 140 after a cycle of uninstallation and reinstallation of the SAC 140 should be provided with fresh individualization data. On the one hand, by issuing the same data, the provider could unilaterally revoke an instance of a SAC 140 that is behaving suspiciously, possibly indicating that the coprocessor 170 on which it runs has been compromised. On the other hand, honest consumers should be allowed to break the linkage of individualization if they so desire in the interests of privacy. Fresh individualization for every installation, whether it is new or a repeat, is therefore desired. This changes the process of revocation of a SAC 140 on a particular coprocessor 170 by the provider responsible for that SAC 140. The Trust Server 150, to whom the provider submits the request, must arbitrate the revocation process. The dual and complementary responsibilities of protecting consumer privacy and of serving provider needs rests on the Trust Server 150.

The table below summarizes the technical notation that is used in the specification.

TABLE I

| Symbol | Meaning |
|---|---|
| <> | Delimiters for an n-tuple or a finite sequence |
| AS | Application Server pertaining to a provider |
| AS.ID | Identifier for an application server. In a preferred |
| | embodiment there may be a one-to-one correspondence |
| | between (application) providers and application |
| | servers. |
| AS.key | Symmetric key generated by an application server and |
| | associated with a SAC-series |
| AS.privKey | The private key of an Application Server. The |
| | corresponding public key is either well-known or |
| | authenticated with a public key certificate, with |
| | identifier AS.ID |
| AS.track | Secret information generated by an application server. |
| | Used to prove continuity of identity to the TS |
| blob | Individualization data for an instance of a SAC. |
| | Generally secret. |
| blobTag | Non-secret information associated with a ‘blob’. |
| | Contains identifying information for a ‘blob’ |
| certID | Identifier for an anonymous public key certificate |
| | (or coupon) |
| Cp | Coprocessor (to consumer computing device) |
| Cp.ID | Identifier for a coprocessor (to a consumer |
| | computing device) |
| CTblob | SAC individualization data in encrypted form |
| Enc(pt, pubKey) | Public key encryption of plaintext ‘pt’ using |
| | public key ‘pubKey’ |
| H(m) | One-way hash function |
| HSM | Hardware Security Module |
| msgKey | Message key |
| privKey | Private key (of a key pair) |
| pubKey | Public key (of a key pair) |
| SAC | Secure Application Component. A software component |
| | that executes on the (secure) coprocessor to a |
| | consumer computing device. A SAC is protected by |
| | physical security |
| SAC.assign | A cryptographically protected data structure |
| | maintained by the TS that binds different pieces |
| | of information associated with a SAC-series |
| | together |
| SAC.exe | The representation of the executable for a |
| | particular SAC |
| SAC.ID | Identifier for a particular version of a SAC |
| SAC.key | Symmetric key generated by an application server to |
| | encrypt a particular version of a SAC for public |
| | distribution, or generated by the TS for a |
| | SAC-series |
| SAC.number | Identifier for a series of versions of a SAC |
| SAC.src | Representation of the source of a SAC. The |
| | executable of a SAC can be derived from SAC.src |
| SAC.version | Version identifier for a particular version of a SAC |
| SAC-series | A series of versions of SAC sharing the same |
| | SAC.number |
| seqAS | A sequence of SAC individualization data together |
| | with their associated blobTag |
| Sign(m, k) | Digital signature operation with message m and |
| | signature key k |
| SymEnc(pt, k) | Symmetric encryption operation with plaintext |
| | pt and key k |
| TS | Trust Server |
| TS.local | A secret value used by the HSM of the TS to secure |
| | local storage |
| TS.privKey | The private key of the Trust Server. |
| TS.pubKey | Public key of the Trust Server. Either well-known or |
| | authenticated with a public key certificate |

The Hardware Security Module (HSM) 160 within the Trust Server 150 is assumed to act as a slave to its master host, but runs its own secured code and can securely retain static values, such as its private key and a secret for local authentication of data retrieved from the Trust Server databases. The HSM 160 is not assumed to possess dynamic state memory, although to the extent such memory is available, it can be used to help secure the Trust Server 150 against containment attacks which involve large-scale cloning of successfully compromised devices. There are several advantages of exploring which aspects of processing and communications can be secured without being dependent on such memory. Effective backup of a dynamically changing HSM 160, and determination of the appropriate responses to hardware failure versus sabotage can be thorny issues to resolve. Although the Trust Server 150 here is a monolithic host/HSM combination, it can be separated into separate components according to functionality. As an example, there could be a single server that interacts with Application Servers 120 in order to handle SAC publishing and bulk individualization. Such a server could act as an interface between Application Servers 120 and multiple device-servers which each relate to a distinct population of client-side coprocessor users. Examples will be given to show that seemingly small modifications of protocol design can greatly affect the security profile of the overall system. Securing a subsystem under reduced hardware expenditure and maintenance requirements can be particularly important if that subsystem is run remotely from others that already have access to more significant resources.

Any data passing between coprocessors 170 and the Trust Server 150 must be protected by authentication and encryption. Care must also be taken to hide evidence of identity of the coprocessors 170 involved. For example, a known structure of ciphertext with an appended signature over the ciphertext would violate this requirement because armed with an exhaustive list of coprocessor public keys, one could attempt signature verifications. The present invention, under the rubric of Secure Communications, specifically requires that any data encrypted by a coprocessor 170 for the HSM 160 cannot be decrypted by an insider at the Trust Server 150; any data encrypted for a coprocessor 170 by the HSM 160 cannot be decrypted by a Trust Server insider; a message cannot successfully be spoofed to a coprocessor 170 as coming from the HSM 160 without accessing data currently held in the Trust Server 150; a message cannot successfully be spoofed to the HSM 160 as coming from a coprocessor 170 without accessing data currently held in the Trust Server 150. It is not assumed that a Trust Server 150 insider cannot successfully spoof data to the HSM 160 as if it came from a coprocessor 170. Similarly, it is not assumed that a Trust Server 150 insider cannot successfully spoof data to a coprocessor 170 as if it came from the HSM 160.

The present invention provides increased trust for transactions between a client using a client computer microprocessor platform and at least one remote server by employing a trusted server 150 configured to accept at least one public key datum, where each public key datum is specifically associated with a client platform as part of a public/private key pair for the platform. The public/private key pair may be generated using at least one of the client platform and the trusted server 150. Additional approval data is also associated with the public key datum to identify the public key datum as having been approved by the trusted server 150 which accepts it. The public key datum and the associated additional approval data are then made available to the remote server, where the remote server is configured to recognize trustworthy additional approval data.

Remote server-specific data is also associated with the approved public key datum, and the associated remote server-specific data is used in conjunction with the client platform private key associated with the public key datum. Through client platform communication with the trusted server, the trusted server is made aware of at least one utilization of the client platform private key with server-specific data from the remote server, giving the trusted server opportunity to accept or reject association of the public key datum with the remote server, and to provide or deny an assurance.

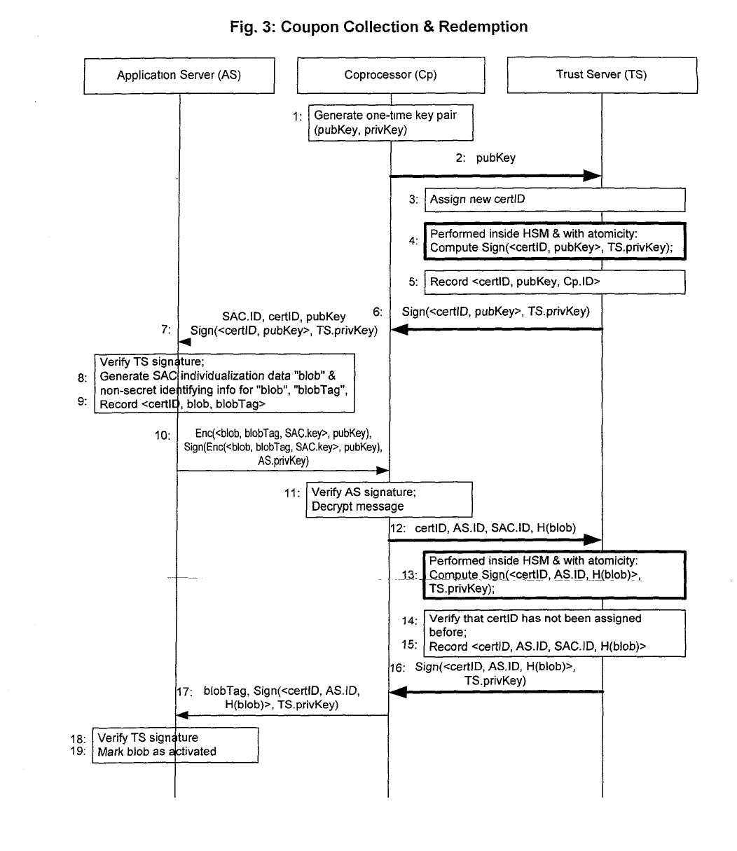

As noted before, the requirement for individualization of a SAC 140 follows from the necessity of a provider to keep track of its separate instances across coprocessors 170. It was also noted that there are two methods for individualizing an SAC 140: by an Application Server 120, and by a Trust Server 150. With reference to FIGS. 2 and 3, a method for SAC Individualization by Application Server 120 is illustrated.

Referring to FIG. 2, a block diagram presenting the encryption process of a Secure Application Component (SAC) by the Application Server (AS) 120 is provided. Prior to public distribution, the Application Server 120 assigns a new identifier SAC.ID to each SAC 140. A symmetric key SAC.key is then generated, which is used to encrypt the SAC 140. The symmetrically encrypted SAC is subsequently made publicly available for distribution.

Referring to FIG. 3, a block diagram presenting a process for coupon collection by a coprocessor 170 and redemption of a coupon with an Application Server 120 is illustrated. The private key (privKey) corresponding to an anonymous certificate or “coupon” is intended to be a coprocessor-level secret that does not leak out of coprocessors 170 which have not been successfully tampered with. Consequently, Application Servers 120 must incorporate the prescribed interactions with coprocessors 170 into their communications code, rather than be given the flexibility to determine the methodology by which alleged coprocessors 170 prove their legitimacy as a condition of successful acquisition of services or content.

An unscrupulous Application Provider might otherwise configure its Application Server to attempt to take advantage of oracles such as those based on the equivalence of Rabin decryption (i.e., the computation of modular square roots) to factoring of the modulus, or on small-subgroup attacks against Diffie-Hellman related protocols. Such remote acquisition of private keys could potentially be used on a wide scale if such a protocol flaw were to go undetected.

Note that the SAC 140 will not be able to be installed on a compliant coprocessor 170 unless (in FIG. 3, step 11) the AS signature is verified properly and the decrypted message yields the key (SAC.key) which was originally used by the Application Server 120 to encrypt the SAC 140 prior to public distribution (in FIG. 2, step 3). The AS.ID is acquired by the coprocessor 170 from the Application Server's public key certificate. Even if the AS 120 chooses to ignore the validity test for the receipt the coprocessor 170 obtains in exchange for redeeming the coupon with the Trust Server 150, the AS.ID has been noted by the TS (Trust Server) 150, so that this information can be logged for tracking (as well as potentially for billing) purposes. If evidence of such a receipt were not made available to Application Servers 120, coupons corresponding to successfully tampered coprocessors 170 could be “multiply spent.” While compliant coprocessors 170 can be tethered to the Trust Server 150 by having them programmed to lose critical functionality if they have not called home after some specified limit on time (or other metric) has been exceeded, successfully tampered coprocessors 170 may avoid such report-back. If they need to report back in order to obtain new keying material, say, they may be able to successfully lie about past activity logs. Note that dependence on the “blob” in the receipt issued by the Trust Server 150, makes it infeasible for even a tampered device to stockpile usable receipts.

The assumptions on Secure Communications between coprocessors 170 and the Trust Server 150 together with the atomicity of operations performed by the HSM 160 make it infeasible for a Trust Server 150 insider acting without collusion of tampered devices to acquire coupons for which it knows the corresponding private keys. These two aspects of the preferred embodiment help to elucidate what it means for a trusted server 150 to be configured to accept a public key datum in the case where the public key datum is received by the trusted server 150 from a client platform under Secure Communications.

The method intentionally does not specify how the (SAC-level) “blobs” (or SAC individualization data) shared between a compliant coprocessor 170 and an Application Server 120 should be used in SAC-level communications between the coprocessor 170 and the Application Server 120.

Potential “misuse” of this data does not affect the security of any independently administered SAC 140.

From a consumer's privacy perspective, a tampered coprocessor 170 alone is unable to undermine users' confidence that they are communicating with an Application Server 120 in possession of knowledge of the AS private key corresponding to the certified AS public key. If, for example, the signed encryption step by the Application Server 120 were replaced by a separate signature and encryption on the data <blob, blobTag, SAC.key>, the following attack could be mounted.

A tampered coprocessor 170 could collect coupons and use them at Application Servers 120 without completing the transaction (in order to prevent the coupons from being marked as redeemed at the TS 150). The tampered coprocessor 170 would presumably be able to extract knowledge of each <blob, blobTag, SAC.key> based on knowledge of the corresponding Enc(<blob, blobTag, SAC.key>, pubKey) and its associated privKey. Since Sign(<blob, blobTag, SAC.key>, AS.privKey) has no dependence on coprocessor-related input, the tampered coprocessor 170 would be able to reuse the <blob, blobTag, SAC.key> encrypted under the target's pubKey value. While the adversary would have access to the plain-text executable, he could, however, be foiled by code within the SAC 140 which expects, say, signatures on data randomly generated by the target coprocessor's instance of the SAC 140. If the adversary had not aborted its use of the coupons with the Application Server 120, the target coprocessor 170 would not unwittingly attempt to communicate any potentially confidential information to the adversary, since the reuse of the coupon would be detected at the Trust Server 150. In any case, this type of attack is thwarted in the actual protocol design, because the signature is over the encryption, which varies based on the coprocessor 170 through use of pubKey.

From a privacy perspective, the user of the client platform should be involved in the determination of whether the particular transaction warrants the disclosure of information to the remote server regarding certificate status, where the authenticity of such information is assured by the anonymizing server or other trusted server 150 or one acting on its behalf. Since this assurance procedure can be designed to be (computationally) unforgeable, such assurances can be requested of the trusted server 150 by the client platform user, and the responses from the trusted server 150 can be delivered to the remote server by the client platform user as well. If the remote server does not receive a satisfactory indication of assurance by some self-specified juncture (which may be a function of time, accumulated access to services, or other metric(s)), the remote server may elect to sever its relationship with the particular client platform user. The remote server can determine the freshness of any assurances it receives, by including appropriate information in the remote server-specific data that it associates with the public key datum, which it expects to see reflected in the assurances produced by the trusted server. This procedure has the additional advantage, if so constructed, of exhibiting proof of possession of the private key corresponding to the public key datum, as well as assurance of certificate trustworthiness. Thus, a trusted server 150 is made aware (under Secure Communications) of at least one utilization of the private key. In the preferred embodiment, server-specific data (namely, blob, blobTag, and SAC.key) is recovered (in step 11 of FIG. 3) by the client platform using the private key to decrypt, where some function of the recovered data (namely, H(blob)) is forwarded to the trusted server 150 with the ID of the remote server (AS.ID, along with SAC.ID). By having the client platform user, rather than the remote server, handle the request for assurance, this enables increased versatility in billing models. If the remote server is to be charged for use of a certificate, it could otherwise opt out of requesting assurance in order to hide from the trusted server its use of the certificate. By restricting the relationship of a client platform to only a single trusted server at any point in time, this allows for more meaningful tracking of certificate usage. While it is known to incorporate expiration dates into certificates, this does not indicate to what extent a certificate has been relied upon and whether it should be considered trustworthy. The use of certificate revocation lists (CRLs) does not satisfactorily address the potential concerns of a remote server: In addition to the usual problems associated with CRLs, such as guaranteed delivery of latest versions, and scalability, the incorporation of client platform user privacy may undermine the effectiveness of CRLs.

The present invention allows for a different approach to revocations: At the advance request of a remote server which specifies a list of certificate IDs, a future client platform user-request for assurance which is associated with remote server-specific data relative to the remote server in question may be denied if the particular client platform is marked at the trusted server as having been associated with one of the suspect certificate IDs. If these remote server-initiated requests are properly authenticated, a remote server will not influence the assurance process relative to other remote servers. Note that this technique is predicated on the fact that there are instances of electronic commerce where a remote server may be in a better position to catch seemingly fraudulent activity on the part of a client platform user than would be a trusted server 150, because the trusted server 150 may not witness the actual electronic commerce transactions such as logging and billing for access to content or services. Furthermore, such transactions may be blinded from the trusted servers because they may be secured based on secret data shared between the client platform and the remote server as enabled by the present invention. The remote server cannot itself recognize whether two certificate IDs correspond to the same client platform if user privacy is enforced. Unlike a trusted server 150, a remote server may not be able to directly influence client platform behavior, even if it can influence the behavior of applications running on the client platform which are under control of the remote server.

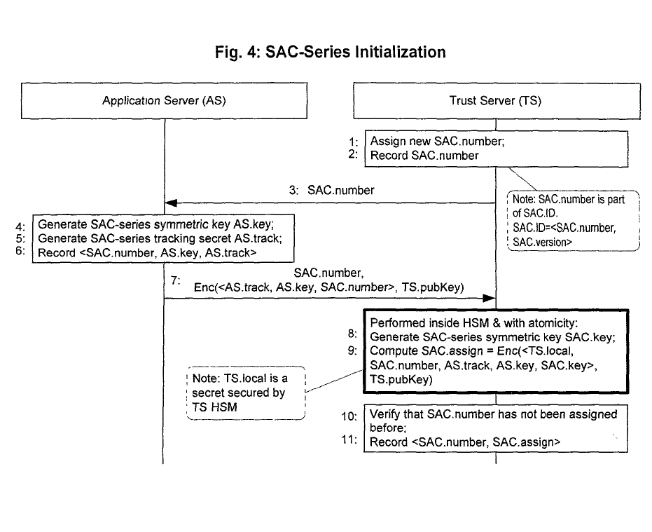

Another method for individualizing a SAC 140 is by a Trust Server 150. With reference to FIGS. 4-7, a method for SAC Individualization by Application Server 120 is illustrated.

For this method, an important containment goal is achieved, namely, knowledge of “additional” pre-stored SAC individualization data is safe even from the combination of Trust Server insiders and successfully tampered coprocessors. More precisely, the only SAC individualization data that is subject to compromise is that which is served to coprocessors 170 which are (or will be) compromised, or their clones. In this method, SAC individualization data is delivered in bulk to the Trust Server 150 and stored for the purpose of dispensing to coprocessors 170 during SAC installation and individualization. This procedure is somewhat analogous to the filling of a PEZ® candy dispenser followed by the dispensing of one candy tablet at a time, each served up once and consumed. Each individualization-data packet dispensed to a coprocessor 170 may comprise a blob of data, as well as a blobTag which can be used for tracking purposes by the Trust Server 150 and to identify to the Application Server 120 which blob value is purportedly held by any particular coprocessor 170 with which it communicates. Successful delivery of content or services to a client platform may be made contingent upon knowledge of the appropriate blob value as accessed by the SAC 140 within the coprocessor's secure environment. Since all versions or upgrades of a SAC 140 corresponding to a given SAC.number are designed to work off the same (replenishable) pool of bulk individualization data, it is not sufficient (although it is necessary) to protect this data from attack during bulk delivery from the Application Server 120, during processing and storage by the Trust Server 150, and during individualization of a SAC instance being permissioned into a coprocessor 170. The SAC publishing process must be protected as well, in order to effect the desired level of security. The issue corresponding to this immediate goal is not one of ensuring the authenticity of the Application Server 120 (or provider) requesting that the SAC 140 be published, but rather one of ensuring that once a SAC series is initialized, a strategy has been put into place which denies intruders, whether legitimate Application Servers 120 or not, the ability to get rogue SACs published. A rogue SAC can misappropriate a target Application Server's individualization data by misusing it or exposing it.

Recall that the first method, discussed earlier, handled both the publishing and signing of SACs outside of the Trust Server 150. Suppose that SAC-series bulk individualization and SAC permissioning is handled as in the current method, but that the Application Server 120 (AS) does its own signing of the SAC 140 and its own publishing, where the AS 120 would generate its own value of SAC.key and send SAC.number, Enc(<AS.track,SAC.key,SAC.number>, TS.pubKey) to the Trust Server 150 for SAC-series initialization. A compromise of a single coprocessor 170 would then enable an adversary to publish a rogue SAC using the same value of SAC.number as the target AS and the same (compromised) value of SAC.key. The attack would not require the complicity of a TS insider, since the adversary need not submit a SAC-series initialization vector. His goal is not to submit his own bulk individualization data, but to hijack the target's.

Consider next, that all the documented protocols are used, but that an AS is allowed to choose its own value of SAC.key rather than having it generated randomly by the TS HSM 160. Then, an attack of a coprocessor 170 yielding the target's value of SAC.key, could be combined with a TS insider attack in which the adversary chooses the same value of SAC.key as did the target, with a forced replay of the same value of SAC.number. The adversary performs the standard SAC-series initialization step with this value of SAC.number, enabling him to have a rogue SAC published which can successfully install and access the target's individualization data, since it shares the same values of SAC.number and SAC.key. Hence, allowing an AS 120 to choose its own value of SAC.key gets around the protection which was offered by including TS.local in SAC.assign (as specified in FIG. 4) in order to prevent insider substitution with an encryption of chosen values.

In order for the actual current method to achieve its resistance against the two-pronged attack of coprocessor compromise and TS insider, an important aspect of the protocol design is that AS.key is generally never made available to coprocessors 170 and is thus not subject to compromise in this way. Without knowledge of the target AS.key, an adversary cannot provide the missing argument necessary to “finally” publish, i.e., provide a verifiable signature. It is also important that there is an unspoofable binding between the signature and the presentation of SAC individualization data to the coprocessors 170. It is known in the prior art that digital signatures supply a means to bind together the arguments of the signature, where the message over which the signature is applied can be construed as comprising several such arguments. Thus, reasoning inductively, one way to bind a datum to an existing signature is to input a function of the datum as an additional argument of the signature.

The present invention enhances trust for transactions between a client using a client computer microprocessor platform and a remote server by employing at least one trusted server and transferring data from the remote server to the trusted server. The transferred data includes at least one secret datum. The transfer is effected in conjunction with data transfer security provisions. A function of a portion of the transferred data is provided from the trusted server to the client platform, where the portion includes at least a part of the secret datum. The trusted server provides a value of the function to the client platform encrypted by at least one key recognizable by the trusted server as associated with a client platform deemed trustworthy. The client platform is operational to decrypt the encrypted function value, so that the function value may be securely shared between the remote server and the client platform.

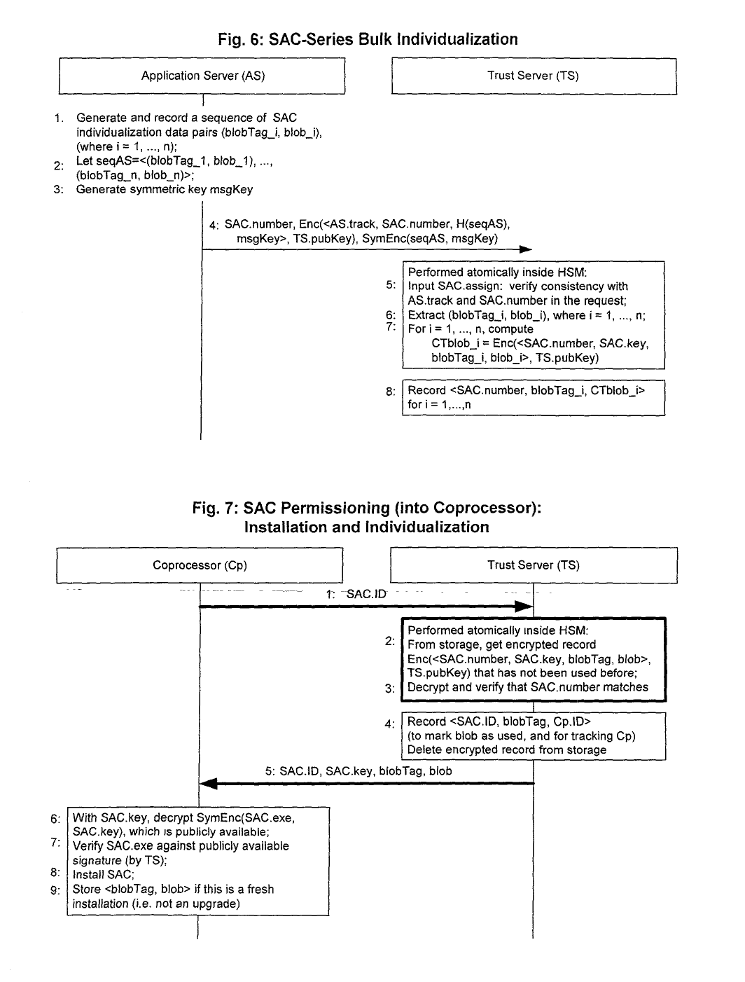

The association of AS.track with the bulk individualization data transferal, as indicated in the message of step 4 of FIG. 6, serves to unambiguously designate which encryption-key value of SAC.key should be appended to SAC individualization values (blobTag, blob) as each is delivered to a coprocessor 170 in the message of step 5 of FIG. 7. The association of the SAC.key value to the SAC individualization values is done as part of bulk individualization in steps 5, 6, and 7 of FIG. 6, based on access by the TS HSM 160 to SAC.assign, as originally computed in step 9 of FIG. 4 during initialization of the given SAC series. Note that maintaining the secrecy of AS.track prevents an adversary from using knowledge of this value in order to resubmit it under the reused SAC.number together with a value of AS.key which he knows, during SAC-series initialization. Such a maneuver, if successful, would allow an adversary to reroute SAC individualization data to a rogue version of the SAC. For the purpose of preventing this rerouting of data for use by a rogue SAC, it would actually suffice to use a non-secret value unambiguously indicative of (but not causing leakage of) the secret value of AS.track (such as H(AS.track)) during bulk individualization, since knowledge of the value of AS.track is necessary in order to submit AS.track together with a known value of AS.key during SAC-series initialization.

Having thus designed a way to securely link individualization data to the correct SAC.key for secure distribution to coprocessors 170, and having designed a way to thwart the successful usable publishing of rogue SACs under a target's secret value of AS.key, it remains to provide a means of securely binding SAC.key to the signature generated by the Trust Server 150 during SAC publishing. The use of SAC.number or SAC.ID does not suffice for this purpose since a TS HSM 160 without sufficient state memory may not be able to track the fraudulent reuse of these values, and these are not intended to be randomly generated each time. The approach taken in the current design is to input H(SAC.key) as an argument of the signature. Within the secure execution environment of the coprocessor 170, the value of SAC.key is used to decrypt the ciphertext form of the SAC 140 and as an input to the signature verification process. This design uses the plaintext (i.e., SAC.key-independent) version of the SAC 140 within the signature to allow coprocessor-independent verification of the signature by the Application Server 120 making a determination as whether to make publicly available the missing argument of the signature that it computes during signature verification based on its knowledge of AS.key. The explicit (although non-secret) use of H(SAC.key) provides the necessary linkage to effect the binding.

The atomic processing of the signature generation during SAC publishing prevents, in particular, insider substitution of a previously published (legitimate) SAC 140 for which SymEnc(H(<SAC.ID, SAC.exe>), AS.key) is known, juxtaposed with a different (rogue) SAC for use in computing the unencrypted argument of the signature, H(<SAC.ID, SAC.exe>).

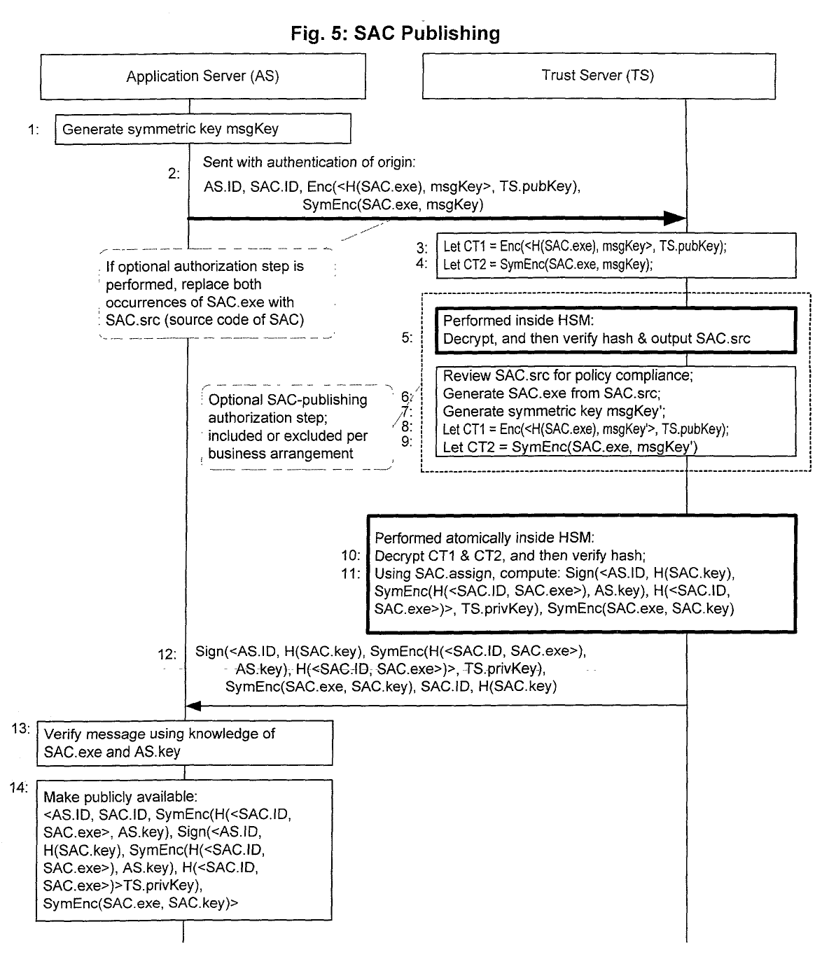

An alternative means of securing the handling of SAC individualization data, which (unlike the SAC.key-based technique) is independent of SAC encryption for the purpose of confidentiality, could proceed as follows: H(SAC.key) as it appears as an argument of the signature in the message transmitted during step 12 of FIG. 5 (SAC publishing), is replaced by H(AS.track). H(AS.track) does not need to be sent along with the signature to the Application Server 120 since, unlike SAC.key (generated by the Trust Server in step 8 of FIG. 4), the appropriate value of AS.track is assumed known by the Application Server 120 which generated it in step 5 of FIG. 4 (SAC-series initialization). While SAC.key in its raw form is transmitted to the client platform in step 5 of FIG. 7 (SAC permissioning) for use by the coprocessor, it is important that a non-secret value indicative of AS.track such as H(AS.track), rather than AS.track itself, be communicated to the coprocessor 170 during the step analogous to this one, since the value of AS.track should not be obtainable through coprocessor compromise. Note that SAC.key may be sent along with H(AS.track) to a coprocessor 170 which needs the value of SAC.key in order to decrypt SymEnc(SAC.exe, SAC.key) because that is the form in which it receives the SAC executable.

Note that during SAC permissioning, an install by a coprocessor 170 of an upgrade versus a fresh install of a SAC 140 (which is characterized by the absence of any currently installed SAC 140 corresponding to that SAC.number), rejects absorption of new individualization data. This attribute makes the system DRM (digital rights management)-friendly in that digital rights data somehow tied to or protected by individualization data can be maintained across upgrades.

This method addresses legacy provider infrastructure issues, allowing the Application Servers 120 to communicate with multi-application coprocessor users alongside users of already existing client-side devices. No preparatory steps are needed to convert over to a secret shared between the Application Server 120 and the coprocessor 170, as was necessary in the first method. Furthermore, even if Application Servers 120 never communicate with the coprocessors 170, instances of a given SAC 140 or mutually trusted SACs can “peer-to-peer” communicate using SAC-level encryption and/or authentication. This can be achieved by having the blobTag include a certificate comprising a public key which corresponds to a private key within blob.

Although not explored further here, there is a potential hybrid approach, which (as in the first method) does not require coordination of SAC individualization data values between the Trust Server 150 and the Application Server 120, but which handles SAC publishing and installation of SACs through the Trust Server 150 (as in the second method).

The consumer's privacy is protected from an attack in which an impostor outside of the Trust Server 150 gets a SAC 140 published under a targeted Application Server's identity, to the extent that the Trust Server 150 enforces authentication of the origin of the executable/source code. In the case where an optional SAC-publishing authorization procedure is followed, there may be additional review of out-of-band documentation supporting the origin of the SAC source code, as well as examination of the source code itself for compliance. The authentication of the origin can be brought directly into the HSM 160 if there is no need for the SAC publishing authorization process. Of course, even if the HSM 160 verifies digitally signed code against a certified signature key, the registration process that that certificate authority (CA) used to authenticate identity before issuing a certificate is also potentially subject to attack.

Undetectably replacing SAC individualization data inside of the Trust Server 150 with known values is potentially an attack against consumer privacy, and not an attack against the provider's goal of containment. Collusion between compromised coprocessors and Trust Server insider attack can result in such substitution by illicitly repeating the dispensing of values of <blobTag, blob> to target coprocessors 170 during SAC permissioning, where such values correspond to those extracted from compromised coprocessors. Because of the assumptions on Secure Communications between coprocessors 170 and the Trust Server 150, and because the input of encrypted bulk individualization data requires authorization (via consistent input of AS.track) by the entity that initialized the SAC series, TS insider attack or compromise of coprocessors alone does not enable such attack.

The preferred embodiment of the process is depicted in FIGS. 6 and 7. Transferal may be associated with coordination between the remote server and trusted server 150 regarding which portions of the data will be deemed to connote which collections of client platform attributes, so that the function values may be provided to client platforms accordingly.

The preferred embodiment allows for trusted delivery of computer object data to a client computer microprocessor platform, where a remote server supplies source data of which the delivered object data is a function. The delivery is accomplished by identifying a secret datum that is known to the remote server. The secret datum is made available to a trusted server and identified with a unique tag. The computer object data is derived from the submitted source data, where the object data is associated with a signature computed by the trusted server and where the signature is a function of the object data. The computer object data is then provided for use at a client platform.

In the preferred embodiment, the secret datum refers to AS.key. AS.key is made available to a trusted server and identified with a unique tag, SAC.number, during SAC-series initialization as depicted in FIG. 4. The source data, comprising source code of a SAC or a SAC executable is submitted to a trusted server 150 in association with SAC.ID which specifies SAC.number as well as SAC.version. FIG. 5, SAC publishing, depicts this transfer of data. The information provided for use at a client platform includes the computer object data in the form of a SAC executable, SAC.exe, made publicly available in encrypted form SymEnc(SAC.exe, SAC.key). The associated signature, Sign(<AS.ID, H(SAC.key), SymEnc(H(<SAC.ID, SAC.exe>), AS.key), H(<SAC.ID, SAC.exe>)>, TS.privKey), is a function fi of the object data through the signature argument H(<SAC.ID, SAC.exe>). In one embodiment, the function f₂ of the object data refers to SymEnc(H(<SAC.ID, SAC.exe>), AS.key). Alternatively, it may be used that f₂(data)=SymEnc(data) and f₃(data)=data. In another embodiment, it may be used that f₂(data)=data and f₃(data)=SymEnc(data).

The present invention provides control of computer object data deriving from source data associated with a remote server, where the object data is usable by a plurality of clients using client computer microprocessor platforms, by identifying a first datum associated with a unique tag. Both the first datum and the associated tag are known to the remote server. A second datum is then associated with the first datum and tag, where the second datum is provided by a trusted server which is configured to store information reflecting the first datum and tag and second datum. Computer object data is then bound to a value computed as a function of a derived datum, wherein the derived datum comprises at least one of data indicative of the first datum and data indicative of the second datum. The binding is performed by the trusted server. An additional data bundle is also formed by associating for the remote server additional data of the remote server with: i) at least one of data indicative of the first datum and data indicative of the second datum and; ii) the associated tag. The additional data bundle is submitted to a trusted server for verification. If the bundle is verified as consistent with the stored information regarding the first datum and tag and the second datum as stored by the trusted server, then the derived datum is associated with functions of the data bundle for delivery to a client platform.

In the preferred embodiment, the first datum comprises AS.track, and the unique tag comprises SAC.number. The second datum comprises SAC.key. Information which comprises SAC.number, AS.track, and SAC.key is stored at a trusted server as SAC.assign (FIG. 4). The derived datum comprises SAC.key, the function is H(·), and the binding is effected by digitally signing, resulting in the signature of step 11 in FIG. 5. The additional data bundle is depicted in step 4 of FIG. 6. The verification for consistency of the submitted data bundle against SAC.assign as indexed by SAC.number is done in step 5 of FIG. 6. The association of SAC.key with functions of the data bundle for (later) delivery to a client platform is depicted in steps 6 and 7 of FIG. 6.

In one embodiment of the invention, the first datum comprises a secret datum. Additionally, the derived datum comprises an encryption key.

In another embodiment of the present invention, the first datum comprises AS.track, and the unique tag comprises SAC.number. Information which comprises SAC.number and AS.track is stored at a trusted server, analogously to the storage of SAC.assign in FIG. 4. The derived datum comprises H(AS.track), the function may be considered to be the identity function, and the binding is effected by digitally signing. Functions of the data bundle are associated with H(AS.track).

Two distinct architectures geared toward the same goal of achieving containment of damage to the business of content and service providers while protecting the privacy interests of consumers who participate in the system have been introduced. These conflicting requirements are best mediated by the introduction of programmable security coprocessors on the consumer end and a trust server which can directly access these devices and so offer permissioning of providers' applications into them while still maintaining user privacy.

Users have a legitimate right to change their personas with respect to activities conducted over the Internet in order to restrict the amount of valuable information that others can glean, often with no commensurate benefit to the consumer. The trust server can deny the permissioning of further services to users who are suspected of noncompliant usage of such services in the analogous way that individual providers could handle their relationships with customers who are known to them. A considerable degree of defense against both insider attacks and consumer fraud can be achieved by careful protocol design and the measured use of hardware security resources on both the consumer and server end. The first of two methods is characterized by a strong PKI (public-key infrastructure) flavor which leans toward making minimal use of trust server involvement in the process. The second approach is capable of handling legacy infrastructures, although it is adaptable to hybrid approaches which can individualize coprocessors with keying material which is able to support both peer-to-peer PKI and coprocessor-to-application server-shared secret based cryptography.

The foregoing merely illustrates the principles of the invention by reference to exemplary embodiments thereof. Various modifications and alterations to the described embodiments will be apparent to those skilled in the art in view of the teachings herein. It will thus be appreciated that those skilled in the art will be able to devise numerous techniques which, although not explicitly shown or described herein, embody the principles of the invention and are thus within the spirit and scope of the invention.

I claim:

1. A method for providing increased trust for secure relationship-based transactions between (1) a client using a client computer microprocessor platform and (2) at least one remote server, comprising the steps of:
(a) employing a trusted server configured to accept at least one public key datum, wherein each said public key datum is specifically associated with the client platform as part of a public/private key pair for the platform, wherein each said public/private key pair may be generated using at least one of: (i) the client platform; or (ii) the trusted server;
(b) associating additional approval data with said public key datum to identify said public key datum as having been approved by the trusted server which accepts said public key datum;
(c) making available to the remote server said public key datum and said associated additional approval data, the remote server being configured to recognize trustworthy additional approval data from said trusted server for approval of said public key datum as trustworthy;
(d) associating remote server-specific data with said approved public key datum, wherein said associated remote server-specific data is used in conjunction with the client platform private key associated with said public key datum, wherein through client platform communication with said trusted server, said trusted server is made aware of at least one utilization of the client platform private key with server-specific data from said remote server, giving said trusted server opportunity to accept or reject the association of said public key datum with said remote server, and to provide or deny an assurance.

2. A method for enhancing trust for transactions between (1) a client using a client computer microprocessor platform and (2) a remote server, the method employing at least one trusted server, the method comprising the steps of:
(a) transferring data from the remote server to a trusted server, said transferred data including at least one secret datum, wherein said transfer is effected in conjunction with data transfer security provisions;
(b) providing from said trusted server to the client platform a function of a portion of said transferred data, wherein said portion includes at least a part of said at least one secret datum, wherein the transferring trusted server provides a value of said function to the client platform encrypted by at least one key recognizable by said trusted server as associated with the client platform deemed trustworthy, the client platform being operational to decrypt said encrypted function value; and
(c) allowing said value of said function to be securely shared between the remote server and the client platform.

3. The method of claim 2, wherein said value of said function provided to the client platform from said trusted server is dependent on attributes of the client platform as known to said trusted server

4. A method for trusted delivery of computer object data to a client computer microprocessor platform, wherein a remote server supplies source data of which the delivered object data is a function, the method comprising the steps of:
(a) identifying a secret datum, distinct from the object data, that is known to the remote server, said secret datum being made available to a trusted server and being identified with a unique tag;
(b) causing source data to be submitted to said trusted server in association with said unique tag;
(c) providing for use at a client platform the computer object data derived from said submitted source data, wherein the object data is associated with a signature computed by said trusted server, and wherein said signature is a function f₁ of said object data.

5. The method of claim 4, wherein said signature further comprises:
(ii) a function f₂ of the object data, and wherein calculation of said function f₂ of the object data given knowledge of the object data requires accurate knowledge of said secret datum.

6. The method of claim 4, wherein said signature further comprises:
(ii) a function f₂ of data, wherein a function value is available to said trusted server, and wherein a function f₃ of data is provided to the remote server, and wherein calculation of said function f₂ of data given knowledge of function f₃ of said data and knowledge of the object data requires accurate knowledge of said secret datum.

7. The method of claim 6, wherein said data is generated at least in part randomly by said trusted server.

8. The method of claim 6, wherein computation of said function f₂ of said data given knowledge of said data and knowledge of the object data requires accurate knowledge of said secret datum.

9. The method of claim 6, wherein computation of said function f₃ of said data given knowledge of said data and knowledge of the object data requires accurate knowledge of said secret datum.

10. A method for providing control of computer object data deriving from source data associated with a remote server, the object data being usable by a plurality of clients using client computer microprocessor platforms, comprising the steps of:
(a) identifying a first datum associated with a unique tag, said first datum and associated tag being known to the remote server;
(b) associating with said first datum and tag a second datum, said second datum being provided by a trusted server which is configured to store information reflecting said first datum and tag and said second datum;
(c) binding computer object data to a value computed as a function of a derived datum, wherein said derived datum comprises at least one of (A) data indicative of said first datum and (B) data indicative of said second datum, wherein said binding is performed by said trusted server;
(d) associating for the remote server: (i) additional data of the remote server; with (ii) at least one of (C) data indicative of said first datum and (D) data indicative of said second datum; and with (iii) said associated tag, to form an additional data bundle;
(e) submitting said additional data bundle to said trusted server and if said bundle is verified as consistent with said stored information regarding said first datum and tag and said second datum as stored by the trusted server, associating said derived datum with functions of said data bundle for delivery to a client platform.

11. The method of claim 10, wherein said first datum comprises a secret datum.

12. The method of claim 10, wherein said derived datum comprises an encryption key.

13. The method of claim 10, wherein said first datum comprises a secret datum and said derived datum comprises an encryption key.

14. A method for providing control of computer object data deriving from source data associated with a remote server, the object data being usable by a plurality of clients using client computer microprocessor platforms, comprising the steps of:
(a) identifying a first datum associated with a unique tag, said first datum and associated tag being known to the remote server;
(b) binding computer object data to a value computed as a function of a derived datum, wherein said derived datum comprises data indicative of said first datum, wherein said binding is performed by a trusted server wherein said trusted server is configured to store information reflecting said first datum and tag;
(c) associating for the remote server: (i) additional data of the remote server, including data indicative of said first datum; with (ii) said associated tag, to form an additional data bundle;
(d) submitting said additional data bundle to said trusted server and if said bundle is verified as consistent with said stored information regarding said first datum and tag as stored by the trusted server, associating said derived datum with functions of said data bundle for delivery to a client platform.

15. The method of claim 14, wherein said first datum comprises a secret datum.

16. The method of claim 14, wherein said derived datum comprises an encryption key.

17. The method of claim 14, wherein said first datum comprises a secret datum and said derived datum comprises an encryption key.

18. A system for providing increased trust for secure relationship-based transactions, comprising:
a at least one remote server;
b a data communications link operationally coupled with said at least one remote server;
c a trust server configured to accept at least one public key datum operationally coupled with said data communications link;
d a client computer microprocessor platform operationally coupled with said trust server, wherein said client computer microprocessor platform is supplied with programming operable to
i employ said trusted server configured to accept at least one public key datum, wherein each said public key datum is specifically associated with the client platform as part of a public/private key pair for the platform, wherein each said public/private key pair may be generated using at least one of: (i) the client platform; or (ii) the trusted server;
ii associate additional approval data with said public key datum to identify said public key datum as having been approved by the trusted server which accepts said public key datum;
iii make available to the remote server said public key datum and said associated additional approval data, the remote server being configured to recognize trustworthy additional approval data from said trusted server for approval of said public key datum as trustworthy;
iv associate remote server-specific data with said approved public key datum, wherein said associated remote server-specific data is used in conjunction with the client platform private key associated with said public key datum, wherein through client platform communication with said trusted server, said trusted server is made aware of at least one utilization of the client platform private key with server-specific data from said remote server, giving said trusted server opportunity to accept or reject the association of said public key datum with said remote server, and to provide or deny an assurance.

19. A system for providing increased trust for secure relationship-based transactions, comprising:
a at least one remote server;
b a data communications link operationally coupled with said at least one remote server;
c a client computer microprocessor platform operationally coupled with said data communications link,
d a trusted server operationally coupled with said data communications link, wherein said trust server is supplied with programming operable to
i transfer data from the remote server to the trusted server, said transferred data including at least one secret datum, wherein said transfer is effected in conjunction with data transfer security provisions;
ii provide from said trusted server to the client computer microprocessor platform a function of a portion of said transferred data, wherein said portion includes at least a part of said at least one secret datum, wherein he transferring trusted server provides a value of said function to the client platform encrypted by at least one key recognizable by said trusted server as associated with the client platform deemed trustworthy, the client platform being operational to decrypt said encrypted function value; and
iii allow said value of said function to be securely shared between the remote server and the client platform.

20. The system of claim 19, wherein said value of said function provided to the client computer microprocessor platform from said trusted server is dependent on attributes of the client computer microprocessor as known to said trusted server.

21. A system for trusted delivery of computer object data, comprising:
a at least one remote server;
b a data communications link operationally coupled with said at least one remote server;
c a client computer microprocessor platform operationally coupled with said data communications link,
d a trusted server operationally coupled with said data communications link, wherein said trust server and said client computer microprocessor platform are supplied with programming together operable to
i identify a secret datum, distinct from the object data, that is known to the remote server, said secret datum being made available to a trusted server and being identified with a unique tag;
ii cause source data to be submitted to said trusted server in association with said unique tag;
iii provide for use at a client computer microprocessor platform the computer object data derived from said submitted source data, wherein the object data is associated with a signature computed by said trusted server, and wherein said signature is a function f₁ of said object data.

22. The system of claim 21, wherein said signature further comprises a function f₂ of the object data, and wherein calculation of said function f₂ of the object data given knowledge of the object data requires accurate knowledge of said secret datum.

23. The system of claim 21, wherein said signature further comprises a function f₂ of data, wherein a function value is available to said trusted server, and wherein a function f₃ of data is provided to the remote server, and wherein calculation of said function f₂ of data given knowledge of function f₃ of said data and knowledge of the object data requires accurate knowledge of said secret datum.

24. The system of claim 23, wherein said data is generated at least in part randomly by said trusted server.

25. The system of claim 23, wherein computation of said function f₂ of said data given knowledge of said data and knowledge of the object data requires accurate knowledge of said secret datum.

26. The system of claim 23, wherein computation of said function f₃ of said data given knowledge of said data and knowledge of the object data requires accurate knowledge of said secret datum.

27. A system for providing control of computer object data deriving from source data associated with a remote server, comprising:
a a plurality of client computer microprocessor platforms;
b a data communications link operationally coupled with said client computer microprocessor platform;
c a trusted server operationally coupled with said data communications link, wherein said trusted server and said client computer microprocessor platform are supplied with programming operable to
i identify a first datum associated with a unique tag, said first datum and associated tag being known to the remote server;
ii associate with said first datum and tag a second datum, said second datum being provided by said trusted server which is configured to store information reflecting said first datum and tag and said second datum;
iii bind computer object data to a value computed as a function of a derived datum, wherein said derived datum comprises at least one of (A) data indicative of said first datum and (B) data indicative of said second datum, wherein said binding is performed by said trusted server;
iv associate for the remote server: (i) additional data of the remote server; with (ii) at least one of (C) data indicative of said first datum and (D) data indicative of said second datum; and with (iii) said associated tag, to form an additional data bundle;
v submit said additional data bundle to said trusted server and if said bundle is verified as consistent with said stored information regarding said first datum and tag and said second datum as stored by the trusted server, associating said derived datum with functions of said data bundle for delivery to said client computer microprocessor platform.

28. The system of claim 27, wherein said first datum comprises a secret datum.

29. The system of claim 27, wherein said derived datum comprises an encryption key.

30. The system of claim 27, wherein said first datum comprises a secret datum and said derived datum comprises an encryption key.

31. A system for providing control of computer object data deriving from source data associated with a remote server, comprising:
a a plurality of client computer microprocessor platforms;
b a data communications link operationally coupled with said client computer microprocessor platform;
c a trusted server operationally coupled with said data communications link, wherein said trusted server and said client computer microprocessor platform are supplied with programming operable to
i identify a first datum associated with a unique tag, said first datum and associated tag being known to the remote server;
ii bind computer object data to a value computed as a function of a derived datum, wherein said derived datum comprises data indicative of said first datum, wherein said binding is performed by said trusted server, and wherein said trusted server is configured to store information reflecting said first datum and tag;
iii associate for the remote server: (i) additional data of the remote server including data indicative of said first datum with (ii) said associated tag, to form an additional data bundle;
iv submit said additional data bundle to said trusted server and if said bundle is verified as consistent with said stored information regarding said first datum and tag as stored by the trusted server, associating said derived datum with functions of said data bundle for delivery to said client computer microprocessor platform.

32. The system of claim 31, wherein said first datum comprises a secret datum.

33. The system of claim 31, wherein said derived datum comprises an encryption key.

34. The system of claim 31, wherein said first datum comprises a secret datum and said derived datum comprises an encryption key.
